(19) United States
(12) Patent Application Publication
(10) Pub. No.: US 2018/0349556 A1
(43) Pub. Date: Dec. 6, 2018

(54) MEDICAL DOCUMENTATION SYSTEMS AND METHODS

(71) Applicant: Nuance Communications, Inc., Burlington, MA (US)

(72) Inventor: Donald Eugene Owen, Orlando, FL (US)

(21) Appl. No.: 15/642,208

(22) Filed: Jul. 5, 2017

Related U.S. Application Data
(60) Provisional application No. 62/514,715, filed on Jun. 2, 2017.

(51) Int. Cl. G06F 19/00; G06F 17/24

(52) U.S. Cl. CPC G06F 19/322; G06F 17/243; G06F 17/248

(57) ABSTRACT

In some aspects, a method of creating and filling a smart medical document is provided, the process of creating and filling being implemented, at least in part, by at least one processor of a host device. The method comprises creating and displaying the smart medical document to a medical professional, receiving input to fill one or more variable fields within the smart medical document, and updating the smart medical document to link the received input to the one or more variable fields.

### CROSS REFERENCE TO RELATED APPLICATIONS

This application claims the benefit under 35 U.S.C. § 119 to U.S. Provisional Application Ser. No. 62/514,715, titled “MEDICAL DOCUMENTATION SYSTEMS AND METHODS,” filed on Jun. 2, 2017, which is herein incorporated by reference in its entirety.

### BACKGROUND

Medical documentation is an important process in the healthcare industry. Most healthcare institutions maintain a longitudinal medical record (e.g., spanning multiple observations or treatments over time) for each of their patients, documenting, for example, the patient's history, encounters with clinical staff within the institution, treatment received, and/or plans for future treatment. Such documentation facilitates maintaining continuity of care for the patient across multiple encounters with various clinicians over time. In addition, when an institution's medical records for large numbers of patients are considered in the aggregate, the information contained therein can be useful for educating clinicians as to treatment efficacy and best practices, for internal auditing within the institution, for quality assurance, etc.

Conventional systems for maintaining medical documentation often rely on a medical professional dictating information related to a patient encounter to update the patient's medical record (e.g., to update the patent's electronic health record (EHR)). To update a patient's record, dictation documenting the patient encounter are typically converted to text by employing a human transcriptionist, using automatic speech recognition (ASR), or a combination of both (e.g., having a transcriptionist review the text output produced by an ASR system and correct the text as needed.

### SUMMARY

Some embodiments include at least one non-transitory processor-readable storage medium storing processor-executable instructions that, when executed, perform a method comprising populating an electronic document with a template comprising standard content and a plurality of variable fields, each of the plurality of variable fields having an associated plurality of selectable options that indicate respective content to be inserted into the respective variable field upon selection of the respective selectable option, displaying the populated electronic document to a user via the electronic display, in response to a first variable field of the one or more variable fields in the displayed electronic document becoming active, displaying to the user via the electronic display the associated plurality of selectable options, and in response to the user selecting one of the plurality of displayed selectable options, inserting into the first variable field the respective content indicated by the displayed selectable option selected by the user.

Some embodiments include a method comprising populating an electronic document with a template comprising standard content and a plurality of variable fields, each of the plurality of variable fields having an associated plurality of selectable options that indicate respective content to be inserted into the respective variable field upon selection of the respective selectable option, displaying the populated electronic document to a user via the electronic display, in response to a first variable field of the plurality of variable fields in the displayed electronic document becoming active, displaying to the user via the electronic display the associated plurality of selectable options, and in response to the user selecting one of the plurality of displayed selectable options, inserting into the first variable field the respective content indicated by the displayed selectable option selected by the user.

Some embodiments include a system for producing documentation, the system comprising an electronic display, at least one storage medium storing processor-executable instructions, at least one processor capable of accessing the at least one storage medium, wherein when the processor-executable instructions are executed by the at least one processor, the at least one processor is configured to perform populating an electronic document with a template comprising standard content and a plurality of variable fields, each of the plurality of variable fields having an associated plurality of selectable options that indicate respective content to be inserted into the respective variable field upon selection of the respective selectable option, displaying the populated electronic document to a user via the electronic display, in response to a first variable field of the plurality of variable fields in the displayed electronic document becoming active, displaying to the user via the electronic display the associated plurality of selectable options, and in response to the user selecting one of the plurality of displayed selectable options, inserting into the first variable field the respective content indicated by the displayed selectable option selected by the user.

Some embodiments include an apparatus comprising: an electronic display, at least one processor, and at least one storage medium storing processor-executable instructions that, when executed by the at least one processor, cause the at least one processor to perform: populating an electronic document with a template comprising standard content and one or more variable fields positioned among the standard content, displaying the populated electronic document to a user via the electronic display, in response to selection of a first variable field of the one or more variable fields in the displayed electronic document, displaying to the user via the electronic display a plurality of selectable options for filling the first variable field, wherein displaying a first selectable option of the plurality of selectable options comprises displaying a first text string identifying the first selectable option to the user, accessing a stored mapping that maps variable field selectable options to document text, wherein the stored mapping maps the first selectable option to a second text string different from the first text string; in response to input from the user selecting the first selectable option for the first variable field, filling the first variable field in the electronic document with the second text string mapped to the first selectable option; and updating the display of the electronic document via the electronic display to include the second text string in the position of the first variable field in the electronic document.

Some embodiments include at least one non-transitory processor-readable storage medium storing processor-executable instructions that, when executed, perform a method comprising populating an electronic document with a template comprising standard content and one or more variable fields positioned among the standard content, displaying the populated electronic document to a user via an electronic display, in response to selection of a first variable field of the one or more variable fields in the displayed electronic document, displaying to the user via the electronic display a plurality of selectable options for filling the first variable field, wherein displaying a first selectable option of the plurality of selectable options comprises displaying a first text string identifying the first selectable option to the user, accessing a stored mapping that maps variable field selectable options to document text, wherein the stored mapping maps the first selectable option to a second text string different from the first text string, in response to input from the user selecting the first selectable option for the first variable field, filling the first variable field in the electronic document with the second text string mapped to the first selectable option, and updating the display of the electronic document via the electronic display to include the second text string in the position of the first variable field in the electronic document.

Some embodiments include a method comprising, via execution of stored instructions by at least one processor, populating an electronic document with a template comprising standard content and one or more variable fields positioned among the standard content, displaying the populated electronic document to a user via an electronic display, in response to selection of a first variable field of the one or more variable fields in the displayed electronic document, displaying to the user via the electronic display a plurality of selectable options for filling the first variable field, wherein displaying a first selectable option of the plurality of selectable options comprises displaying a first text string identifying the first selectable option to the user, accessing a stored mapping that maps variable field selectable options to document text, wherein the stored mapping maps the first selectable option to a second text string different from the first text string, in response to input from the user selecting the first selectable option for the first variable field, filling the first variable field in the electronic document with the second text string mapped to the first selectable option, and updating the display of the electronic document via the electronic display to include the second text string in the position of the first variable field in the electronic document.

### BRIEF DESCRIPTION OF DRAWINGS

Various aspects and embodiments of the application will be described with reference to the following figures.

FIG. 1 illustrates an exemplary medical documentation system in which smart medical documentation techniques may be implemented, in accordance with some embodiments.

FIG. 2 illustrates a method of creating and populating a smart medical document, in accordance with some embodiments.

FIG. 3 illustrates a method for inserting content into a variable field of a smart medical document, in accordance with some embodiments.

FIG. 4 illustrates a method of using default content to assist in completing a smart medical document, in accordance with some embodiments.

FIG. 5 illustrates a method for annotating a smart medical document with medical codes, in accordance with some embodiments.

FIGS. 6A-6G illustrate screen shots of an interface to allow a user to interact with a smart medical document, in accordance with some embodiments.

FIG. 7 illustrates a “quick-view” mode to facilitate providing content to variable fields of a smart document, in accordance with some embodiments.

FIG. 8 illustrates a computer system on which techniques described herein may be implemented.

### DETAILED DESCRIPTION

As discussed above, medical documentation is often produced using human transcriptionists, either to transcribe a medical professional's dictation from audio and/or to review and edit text produced by an ASR system. However, this workflow is both time and cost intensive and vulnerable to human error. In particular, use of a transcriptionist requires specialized staff to review and/or transcribe dictation, introducing cost, delay and potential error into the workflow. Not only is transcription and review costly and time intensive, inevitably some errors (either introduced by ASR or by a human transcriptionist) will escape the attention of the transcriptionist and propagate to the medical professional. The medical professional will either notice the error and need to manually correct the error, or the error remains unnoticed, potentially leading to inaccurate patient records, problems with billing and reimbursement and/or incorrect treatment of patients.

Moreover, many conventional medical documentation systems require a medical professional to dictate all of the pertinent documentation for a patient encounter, placing the burden of significant data entry (e.g., via speech) on the medical professional, who may not possess or have access to all of the information needed to dictate comprehensive documentation of a patient encounter. Accordingly, there are significant problems with the workflow of conventional medical documentation systems, including cost and time delay for systems employing a transcriptionist in the workflow, and drawbacks associated with the time, tedium and cost incurred when requiring a medical professional to dictate significant amounts of information to document a patient encounter.

To address problems of conventional medical documentation systems, the inventor has developed techniques that eliminate the need for a human transcriptionist and/or reduces the data entry burden on the medical professional. According to some embodiments, a smart medical document for documenting a patient encounter is provided that can be completed by a medical professional directly to eliminate the requirement that a human transcribe dictation and/or review and edit text produced by an ASR system that automatically transcribes dictation of the patient encounter, thereby eliminating the associated costs and delay, as well as preventing errors introduced by a transcriptionist either through lack of experience in the medical professional's domain or through simple human error (e.g., via incorrect transcription, overlooking errors produced by ASR, etc.).

The inventor recognized that significant portions of medical documentation (e.g., medical reports documenting a patient encounter) correspond to standard or boilerplate language, narrative generic to a particular type of patient encounter, or any other standard content that may be re-used so that this content can be populated automatically (e.g., via a template) without the medical professional having to dictate or otherwise enter this information, and the medical professional may then review the standard content and edit it as needed (e.g., add, delete or other modify the standard content). Automatically generating this standard content may substantially reduce the burden on the medical professional who no longer has to dictate a potentially large body of information that may be substantially the same across patient encounters. The inventor has further recognized that the burden placed on the medical professional by conventional medical documentation systems can be further reduced or alleviated by presenting portions of a medical report needing attention and/or input from the medical professional as an input field, and providing a number of options to the medical professional to populate the input fields in the medical report (e.g., by providing and/or selecting content specific to the patient encounter being documented.

According to some embodiments, an electronic document is provided to the user to document a patient encounter. The electronic document may be initially populated using a template comprising fixed text and a plurality of variable fields, the content of which is to be confirmed, provided or selected by the user to document the patient encounter. The term “standard content” refers herein to any content that is pre-populated in an electronic document (e.g., via a template) that can be reviewed and edited using standard editing techniques as needed. For example, the standard content may include a narrative (e.g., a fixed text narrative) of a procedure or common aspects of the procedure, may include any narrative or other content (e.g., identification information for the medical professional, patient information, etc.) that the medical professional has indicated should be included when a medical report is generated or obtained, and/or may include other content such as time and date information, image content, links (e.g., hyperlinks) to other information such as other medical reports or documents, content available via a network, etc., as the type and/or nature of the standard content is not limited in this respect. Standard content in the form of text (e.g., a text narrative that is pre-populated in an electronic document) may also be referred to as “fixed text” to indicate that this text corresponds to template language (e.g., standard language or customized language). It should be appreciated that while fixed text may in many cases not require editing, the fixed text is presented to the user (e.g., to provide context for the variable fields) so that the user can edit the fixed text as appropriate.

The term “variable field” refers herein to any type of construct to which content may be inserted and/or any type of placeholder indicating where content is to be inserted, including a field to which content may be inserted, descriptive text that can be replaced by selected content, or any other construct associated with a plurality of selectable options that each indicate content to be inserted into or in place of the variable field upon selection of the respective selectable option. The use of variable fields may facilitate more efficient, cost effective and/or less error prone documenting of a patient encounter compared to conventional medical documentation processes, as discussed in further detail below. For example, a variable field may operate as a placeholder for content corresponding to the specific patient encounter being documented and may, for example, include an indication of the nature of the content of the variable field, default content for the variable field, a link to specific content, etc. A variable field may also include another variable field and/or a link to another variable field to created nested variable fields, as the aspects are not limited in this respect.

According to some embodiments, a smart medical document is displayed on a host device, such as a mobile device (e.g., a cellular telephone, tablet, notepad, personal digital assistant, etc.), laptop computer, desktop computer, or any other suitable device. The smart medical document may be generated by the host device or by an external device connected to the host device. The user, such as a doctor or other medical professional, may then fill out the smart medical document, assisted by one or more of the techniques described herein. A medical professional refers herein to a person qualified in the practice of medicine, psychiatry, or psychology, including, but not limited to, general physicians, clinicians, specialists such as radiologists, cardiologists, etc., surgeons, psychiatrists, psychologists, therapists, or other licensed health care professionals. Filling out the smart medical document may comprise navigating one or more variable fields and selecting or entering information relevant to the specific patient encounter being documented.

According to some embodiments, a medical documentation system provides a smart medical document that comprises both standard content and one or more variable fields. The standard content may include language that is not patient specific and that is, at least in part, generic to the type of patient encounter (e.g., generic to the procedure, operation, treatment, etc., being documented), and so may require minimal editing if any, thus reducing the burden on the medical professional while providing context for the one or more variable fields. As discussed in further detail below, the standard content may include a generic narrative of the procedure produced by experts in the field and/or generated by a medical professional that can be re-used over multiple patient encounters.

A smart medical document may be configured to receive input from the medical professional to fill in, complete or otherwise populate the variable fields in the document and/or confirm the content of one or more variable fields presented to the medical professional. The medical professional may be provided with the option of providing input to the smart medical document through a number of means to complete the variable fields as needed, to confirm information that has been entered into a variable field (e.g., as a default value), to edit the standard content if needed, etc.

Following below are more detailed descriptions of various concepts related to, and embodiments of, methods and apparatus for implementing a smart medical document. It should be appreciated that various aspects described herein may be implemented in any of numerous ways. Examples of specific implementations are provided herein for illustrative purposes only. In addition, the various aspects described in the embodiments below may be used alone or in any combination, and are not limited to the combinations explicitly described herein.

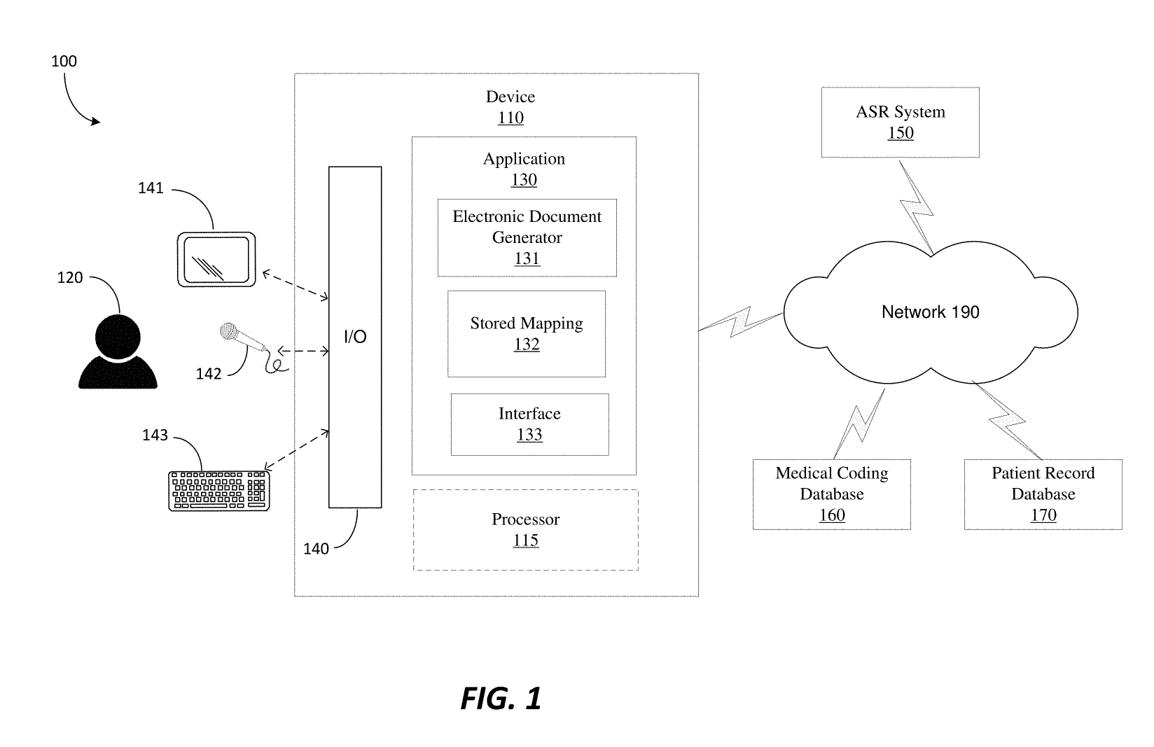

FIG. 1 illustrates a system 100 by which techniques for providing a smart medical document may be implemented, in accordance with some embodiments. System 100 may comprise a device 110 (e.g., a smart phone, tablet, notepad, personal digital system, laptop computer, desktop computer, etc.) that is operated by user 120. User 120 may be a medical professional, as described above, or any other suitable user of the system 100. Device 110 may comprise an input output (I/O) module 140, and application 130, which may be implemented via processor 115, which itself may communicate with I/O module and/or one or more external devices connected to network 190 (e.g., one or any combination of a local area network (LAN), a wide area network (e.g., the Internet), one or more public or private networks, a cellular network, etc.).

Application 130 may be configured to generate and/or modify the smart medical document in conjunction with input from user 120 via I/O module 140. I/O module 140 may interface with any of the input or output systems connected to device 110, such as display 141, microphone 142, or keyboard or keypad 143. Any of the input or output systems may be physically integrated into the device 110, connected to the device 110 either via a wired or wireless connection, or digitally displayed by the mobile device 110 (e.g., rendered on display 141). For example, keyboard or keypad 143 may be integrated hardware or external hardware connected to the device 110 through any suitable interface, or may be a virtual keyboard or keypad displayed to the user 120 through the display 141 (e.g., a touch screen or speech enabled display).

Application 130 may be configured with an electronic document generator 131 and a stored mapping 132 that together provide functionality facilitating smart medical document techniques described herein. For example, electronic document generator 131 may generate a smart medical document having standard content and one or more variable fields, and stored mapping 132 may associate content for the variable fields with information presented to the user via interface 133. The associations managed by stored mapping 132 may facilitate populating the smart medical document with appropriate content based on the interactions of user 120 with interface 133, which may be presented to user 120 on display 141 and/or utilize any one or combination of components coupled to I/O module 140. Interface 133 may comprise a plurality of interface elements that facilitate efficiently obtaining input from the user (e.g., via touch, speech, text, computer mouse, etc.) to populate the smart medical document with appropriate content, some techniques of which are described in further detail below.

It should be appreciated that application 130 may comprise one or more software components executed by one or more processors resident on mobile device 110 (e.g., processor 115) and/or executed by one or more processors accessible via network 190 (e.g., executed by processor(s) operating on one or more network connected devices, servers, etc.). That is, application 130 may comprise one or more local components, one or more external or remote components accessible via a network, or a combination of both. Accordingly, functionality provided by application 130 may be local and/or may be distributed over multiple devices.

In some embodiments, system 100 may additionally comprise one or more of automated speech recognition (ASR) system 150, a billing data base 160, and a patient record database 170 to assist in various aspect of the medical documentation process. ASR system 150 may be used to process speech input from user 120 to convert speech into a format (e.g., text) usable by device 110. ASR system 150 provides a mechanism by which the user (e.g., medical professional) can input data into the smart medical document (e.g., to input content, to make a selection presented via interface 133, etc.), adding another mechanism for populating a medical report. For speech enabled smart documents, an interface element may be presented to the user to allow the user to indicate an intent to input information via speech (e.g., an icon on a graphical user interface presented on interface 133), and to engage the microphone to capture speech, some examples of which are described in further detail below.

Medical coding database 160 may contain medical billing information, such as billing information related to hospital procedures, medical coding information for documentation and billing purposes, etc. Modern medical documentation processes often involve medical coding procedures in which documentation of a patient encounter, such as the patient's diagnoses and clinical procedures performed, is classified according to one or more standardized sets of codes for reporting to various entities such as payment providers (e.g., health insurance companies that reimburse clinicians for their services). In the United States, some such standardized code systems have been adopted by the federal government, which then maintains the code sets and recommends or mandates their use for billing under programs such as Medicare.

For example, the International Classification of Diseases (ICD) numerical coding standard, developed from a European standard by the World Health Organization (WHO), was adopted in the U.S. in version ICD-9-CM (Clinically Modified), and is mandated by the Health Insurance Portability and Accountability Act of 1996 (HIPAA) for use in coding patient diagnoses. Another example of a standardized code system adopted by the U.S. government is the Current Procedural Terminology (CPT) code set, which classifies clinical procedures in five-character alphanumeric codes. Some standard terms and/or codes may be derived from a government or profession-wide standard, such as SNOMED (Systematized Nomenclature of Medicine), UMLS (Unified Medical Language System), RxNorm, RadLex, etc. Other standard terms and/or codes may be more locally derived, such as from standard practices of a particular locality or institution. Medical coding database 160 may store the appropriate medical codes to facilitate the medical coding aspect of the medical documentation process, as discussed in further detail below.

Patient record database 170 may contain records of patient information, such as previous procedures, visits, and any medically pertinent information. Many healthcare institutions have transitioned to electronic medical record systems, in which patients' longitudinal medical information is stored in a data repository in electronic form. Record-keeping with electronic storage methods and the use of electronic medical records provides beneficial time savings and other opportunities to clinicians and other healthcare personnel. Electronic medical records can be shared, accessed and updated by multiple different personnel from local and remote locations through suitable user interfaces and network connections. A connection to patient record database 170 (e.g., via network 190) allows system 100 to access patient data and to update a patient's medical records with a medical report completed via the smart medical document techniques described herein. In addition, information in patient record database 170 may promote more efficient completion of a smart medical document of a patient encounter, as discussed in further detail below.

It should be appreciated that the components of system 100 may be implemented in any suitable way and deployed in any configuration, either as local components executing on device 110, as distributed components accessible via network 190, or a combination of local and distributed components. For example, any one or combination of the form generator 130, the stored mapping 132, ASR system 150, medical coding database 160, and patient record database 170 may be implemented, in full or in part, on device 110 or implemented externally to and/or remotely from device 110 (e.g., implemented via one or more network connected servers, accessible via network 190).

In some embodiments, a “thin client” approach may be used, where principle components utilized by the system (e.g., any one or combination of the form generator 130, stored mapping 132, ASR system 150, medical coding database 160, and/or patient record database 170) are implemented externally and accessed by device 110 through a network connection (e.g., an internet connection), cloud gateway, local area network, or any suitable means for access (e.g., via access to network 190). In other embodiments, a “thick client” approach may be used, where principle components utilized by the system (e.g., any one or combination of form generator 130, stored mapping 132, ASR system 150, medical coding database 160, and/or patient record database 170) are implemented on device 110. Accordingly, system 100 may be implemented having any one or combination of components implemented, or partially implemented, via device 110 and any one or combination of components implemented via one or more network connected devices (e.g., devices connected to network 190), as the aspects are not limited for use with any particular implementation.

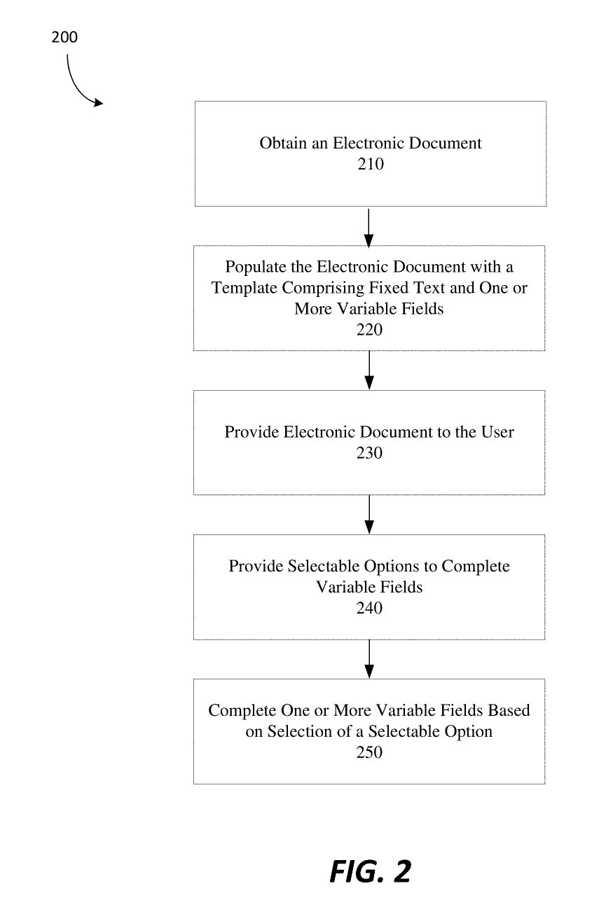

FIG. 2 is a flow chart illustrating a method of assisting a user in producing a medical report using a smart medical document, in accordance with some embodiments. Method 200 may be performed, for example, using one or more of the components illustrated in the exemplary system 100 illustrated in FIG. 1 (e.g., using application 130 operating a device 140). Method 100 may be initiated by performing act 210 in response to a user indicating an intent to document a patient encounter. For example, a medical professional may launch an application residing on or accessible via a mobile device operated by the medical professional. In response, an electronic document may be obtained, for example, by loading an existing electronic document for additional input by the user or by generating a new electronic document. The electronic document obtained in act 210 may be based, at least in part, on preliminary information provided to the application by the user regarding the specific patient encounter for which documentation is desired. For example, a medical professional may provide information regarding the identity of the patient, the nature of the patient encounter (e.g., regular check-up, relevant medical procedure(s), treatment, surgery, etc.), identifying information of the medical professional, etc.

According to some embodiments, preliminary information is obtained by the application via an interface presented to the user that permits entry of any preliminary information needed to obtain and/or generate an electronic document for documenting the patient encounter. For example, the application may present interface components that allow the user to select a template to use in generating a medical report, open an existing electronic document to provide additional input, login to the system, etc. However, it should be appreciated that, in some embodiments, act 210 is performed without obtaining preliminary information from the user to obtain and/or generate an electronic document, as the aspects are not limited in this respect.

In act 220, the electronic document may be populated with a template comprising standard content and one or more variable fields. The standard content may include language descriptive of the type of patient encounter being documented. For example, the standard content may include a standard narrative of the procedure, operation and/or treatment involved in the patient encounter, including any standard or “boilerplate” language, any language previously specified by the medical professional and/or any other language that may be generic across the corresponding patient encounter being documented. As discussed above, the standard content may also contain any language pre-selected in the template by the user, so that the pre-selected language appears in any new instance of the electronic document being generated with the template. For example, the standard content may include language previously input (e.g., dictated, typed or otherwise specified) by the medical professional that can be re-used in documenting patient encounters of the type corresponding to the template and/or the standard content may include any language specified by the medical profession to be automatically populated when creating an electronic document for a patient encounter. As discussed above, standard content is not limited to text and my include any content including, but not limited to, images, tables, portions of other medical documents, links to other medical documents, or any content that an electronic document can be populated with and presented to the medical professional for review and/or editing.

By populating an electronic document with standard content, the user is relieved of the burden of inputting (e.g., dictating or typing) relatively substantial amounts of information. In addition, the cost, delay and error introduce by conventional medical documentation systems that rely on transcribing a medical professional's dictation of this information (e.g., via human transcription, ASR, or a combination of both) can be greatly reduced or eliminated. It should be appreciated that while the standard content may often remain unchanged from documentation to documentation, the standard content may be made editable to allow the standard content to be modified as needed (e.g., standard content can be added, deleted or edited to conform to the specific patient encounter and/or tailored to the context of the specific patient encounter being documented).

As discussed above, the template may include one or more variable fields requiring input, review and/or confirmation from the user. The one or more variable fields may be presented to the user within the standard content, so that the user can understand the context of the corresponding variable fields. However, one or more variable fields may be presented separately from the standard content (e.g., in a quick-view or overview presentation), as discussed in further detail below. Each of the variable fields may be associated with information that can be presented to the user to allow the user to efficiently insert content into the variable field, confirm the content of a populated variable field and/or otherwise assist the user in completing the variable field, examples of which are discussed in further detail below. By populating the template with the standard content and associated variable fields, a smart medical document can be provided that facilitates a medical professional in quickly and efficiently completing a medical report without having to input the entirety of the text (e.g., the entire narrative of the procedure or treatment), limiting the burden on the medical professional to providing the information that is specific to the patient encounter being documented, as indicated by the variable fields. As a result, the time and effort needed to document a patient encounter can be significantly reduced. In addition, transcription efforts may be eliminated from the workflow, further reducing the time and cost of the medical documentation process and/or reducing the amount of error introduced in documenting a patient encounter.

In act 230, the populated electronic document may be provided to the user for completion. For example, at least a portion of the standard content and the one or more variable fields may be displayed to the user via the electronic display of the user's mobile device. According to some embodiments, the standard content may be displayed in association with one or more variable fields to provide context to assist the user in inserting content, confirming the contents of, and/or completing the variable fields. According to some embodiments, one or more variables fields are presented in association with descriptive information, but without presenting the standard content to the user simultaneously, some examples of which are described in further detail below. The electronic document may be provided to the user by displaying a portion of the document (e.g., a portion of the standard content and/or variable fields) to the user, and allowing the user to scroll through or otherwise navigate the document to facilitate completion of document by the user.

In act 240, a plurality of selectable options may be provided to the user for completing the variable fields of the electronic document. According to some embodiments, each of a plurality of variable fields in the electronic document are linked to or otherwise associated with a plurality of selectable options that, for example, may be presented to the user via user interface elements on a display of the device through which the user interacts with the electronic document. Each of the plurality of selectable options provides an indication of the content to be inserted into the corresponding variable field upon selection of the respective selectable option. As discussed in further detail below, the indication of the content presented by respective selectable options may be the content itself, a shorthand for the content, an abbreviation for the content, an excerpt of the content, or any other indication that provides the user with an understanding of what content is to be inserted into the corresponding variable field upon selection of the respective selectable option.

As an example to illustrate completing a variable field via an associated plurality of selectable options, a medical professional may want to document a knee surgery performed on a patient and may engage with a smart medical document system to obtain an electronic document corresponding to this procedure (e.g. by performing act 210). The electronic document may be populated using a template having standard content comprising a standard (or custom) narrative describing the procedure and one or more variable fields requiring input from the user (e.g., by performing act 220). The one or more variable fields may correspond to the laterality of the operation (i.e., which knee was operated on), specific techniques that were used, facts about the specific knee injury, measurement on the anatomy, results of tests performed, etc. When a variable field corresponding to the laterality of the operation becomes active, a plurality of selectable options may be displayed indicating laterality options (e.g., selectable options of “right,” “left” and “both”) so that the user may indicate whether the operation was performed on the right, left or both knees by selecting the corresponding selectable option. Upon selection of one of the plurality of options, the corresponding content associated with the selectable option is inserted into the respective variable field to facilitate efficient completion of the laterality variable field.

Selectable options indicating content to be inserted into respective variable fields may be presented to the user (e.g., via user interface elements) and interacted with using one or more different mechanisms. For example, if the device on which the user is completing the electronic document includes a display that is touch capable, the user may tap on one of the displayed selectable options, or use a computer mouse to select one of the options. Alternatively, the user may use the microphone to select an option via speech, or use a keyboard or keypad (either physical or virtual) to enter one of the options, as the aspects are not limited for use with any one or combination of interface elements, capabilities and/or functionality.

In act 250, one or more variable fields of the electronic document are completed based on selection by the user of one of the plurality of selectable options associated with the respective variable field. According to some embodiments, one of the variable fields is made active to facilitate completion of the variable field. For example, the active field may initially be the first variable field in the electronic document. The next variable field in the electronic document may become active when the user provides input to complete the currently active field. A variable field may become active in other ways, such as the user selecting one of the variable fields via the user interface. The active field may be highlighted or other emphasized to show which is the active field to which user input will be directed.

According to some embodiments, one or more interface elements may be presented to the user to allow the user to quickly iterate through the variable fields, activating each variable field in turn, allowing the user to skip over, return to, or complete a variable field, facilitating completion of the variable fields in any order desired by the user. The variable fields may be made active by other interface mechanisms as well, such as the user selecting a desired variable field via a touch display, mouse, keyboard or keypad, etc. When a variable field is active (e.g., selected by the system or the user), the plurality of options for filling in the active field may be presented to the user to facilitate efficient and accurate completion of the respective variable field. Other information such as a descriptor of the variable field that indicates the type of content that the variable field is associated with, or any other information to assist in completing the variable field may also be presented to the user when the respective variable field is made active.

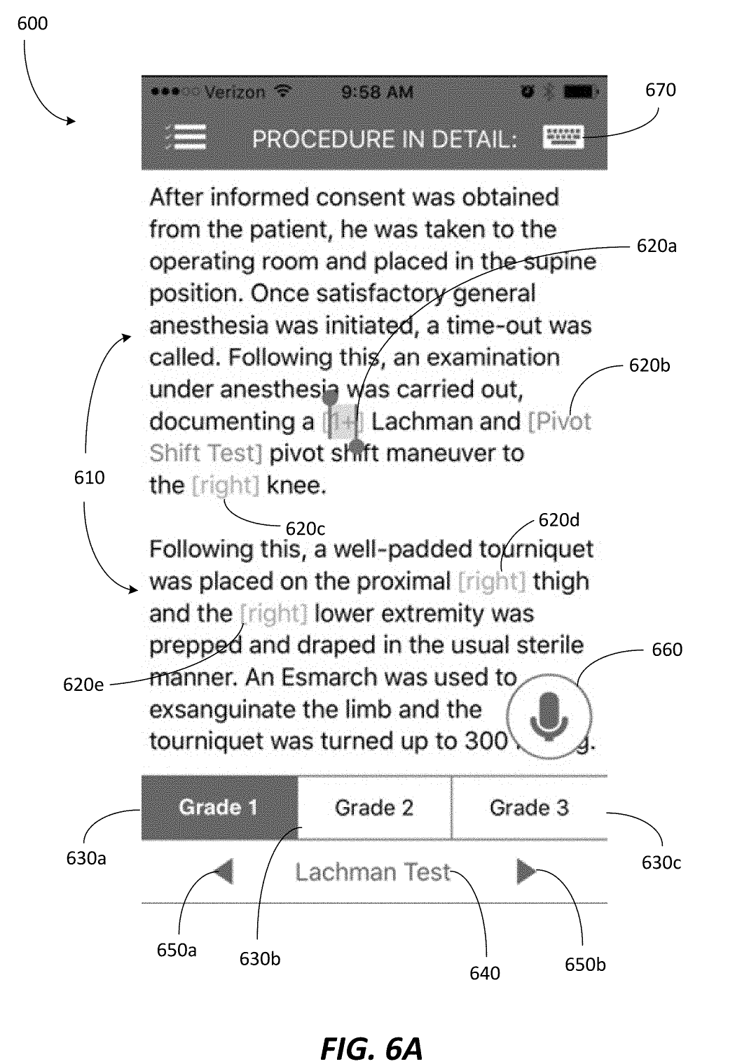

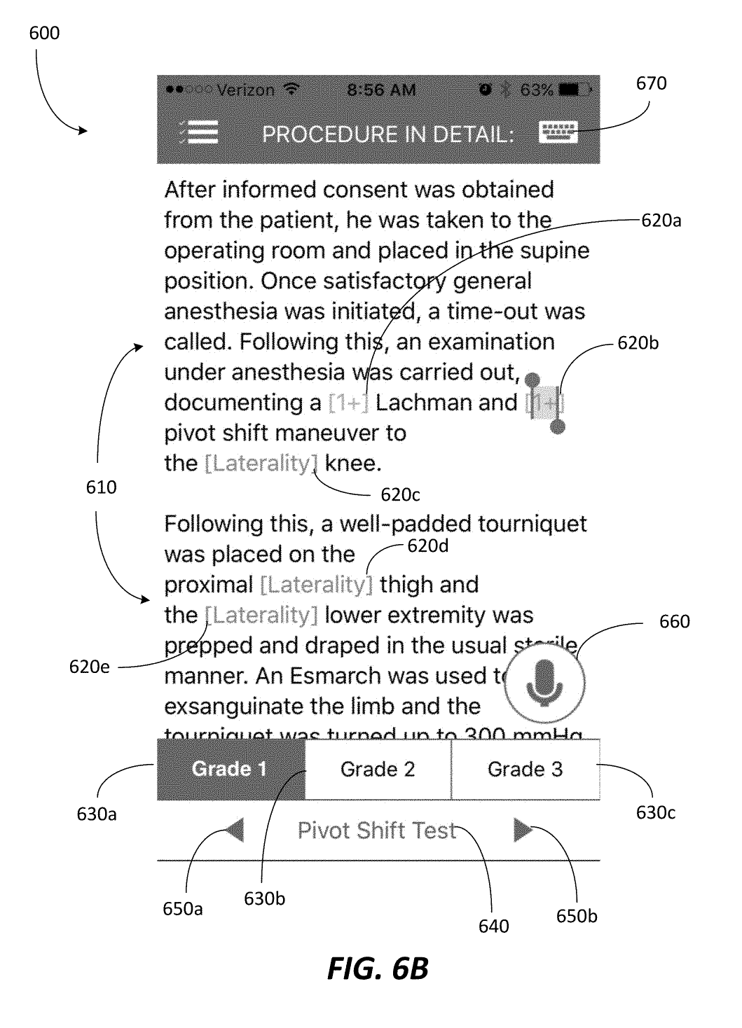

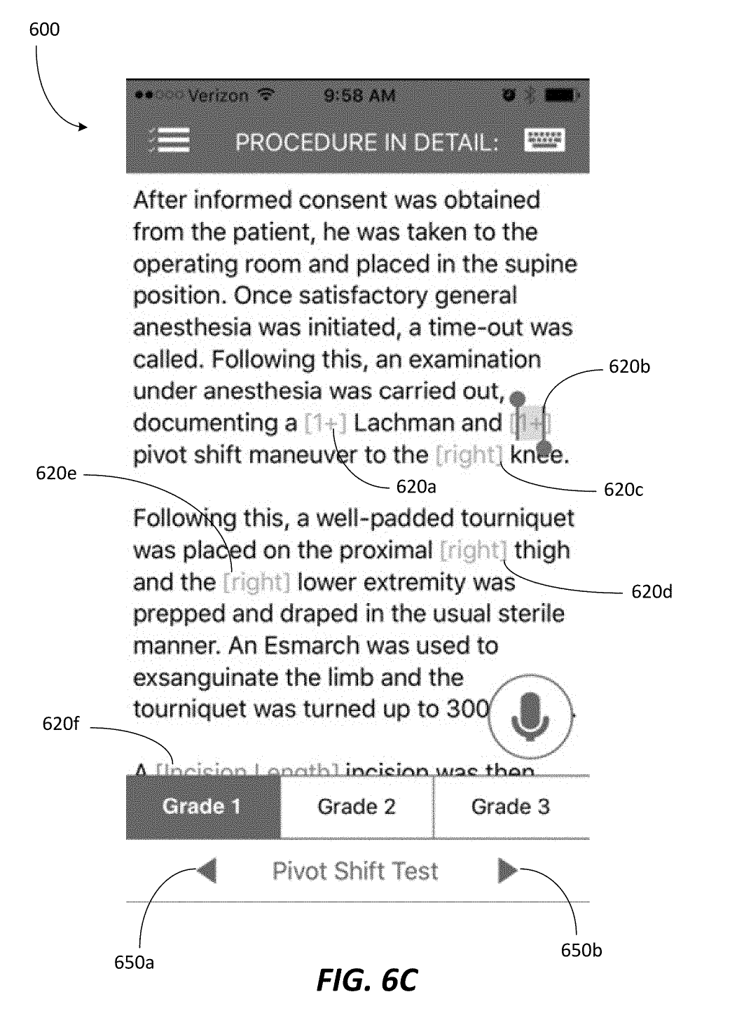

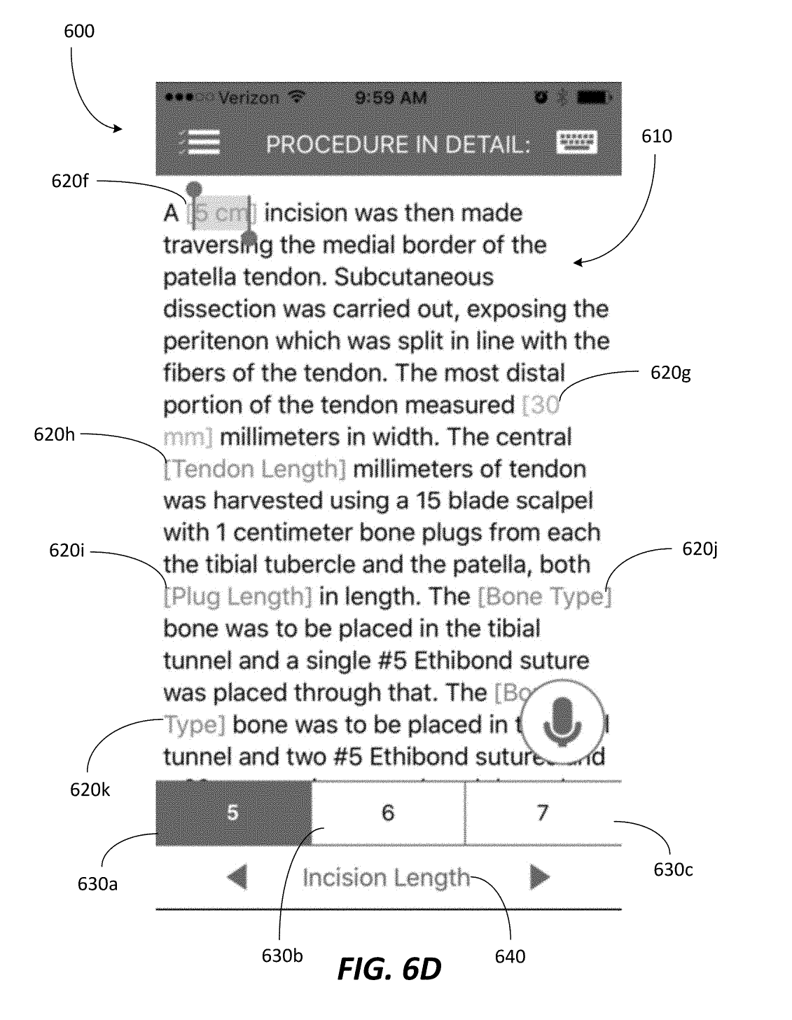

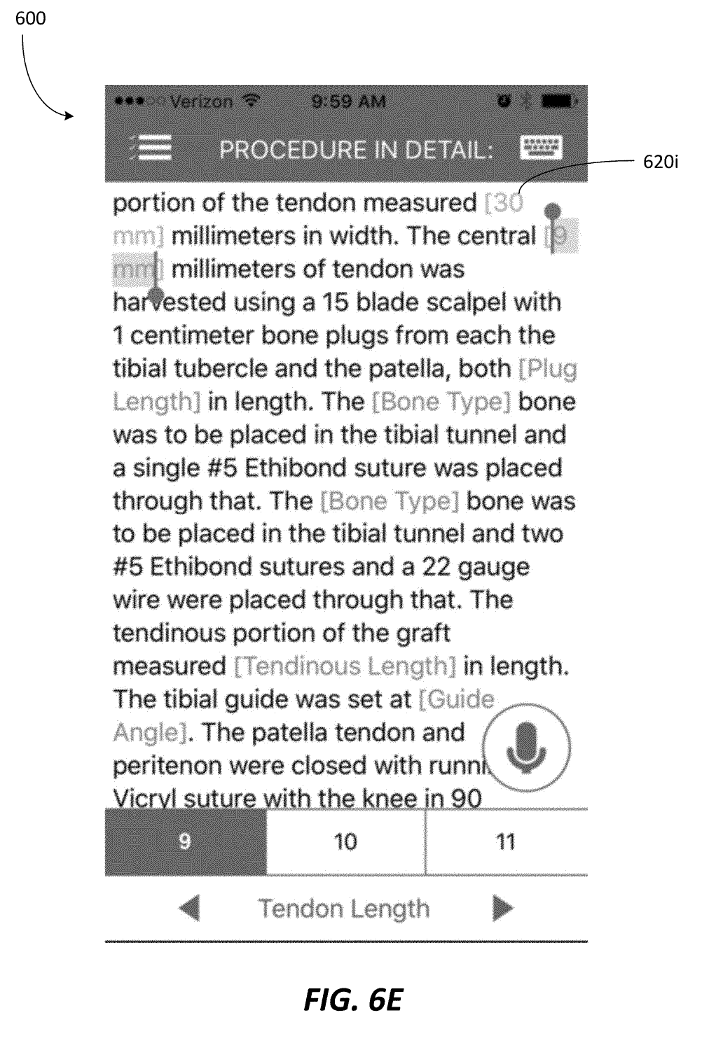

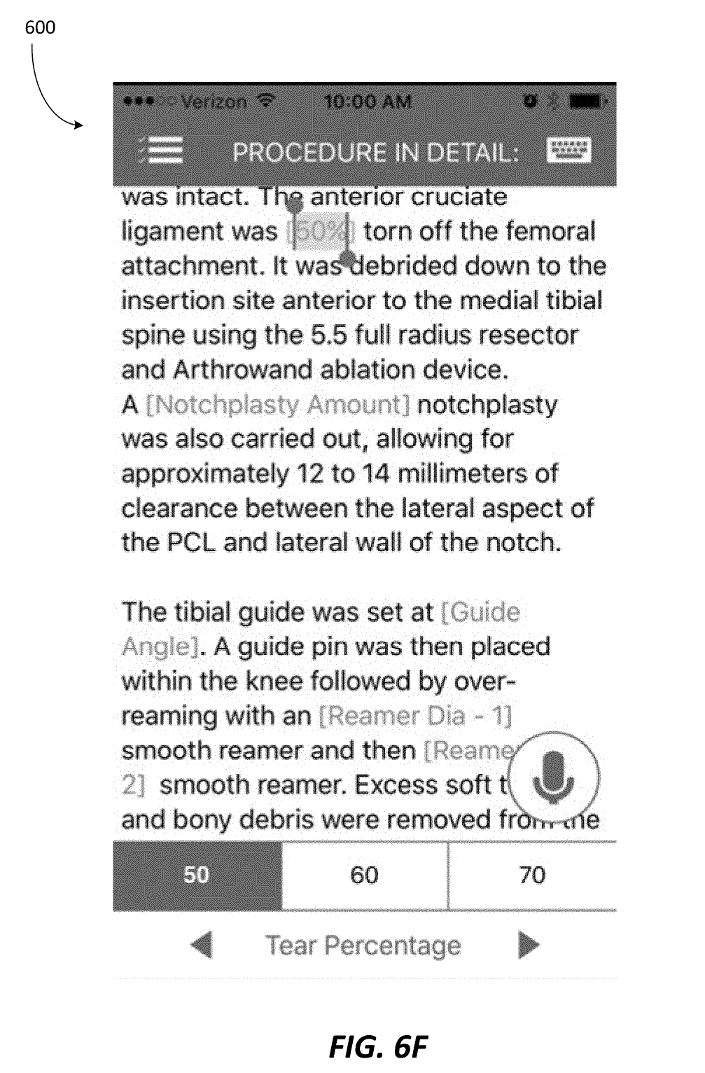

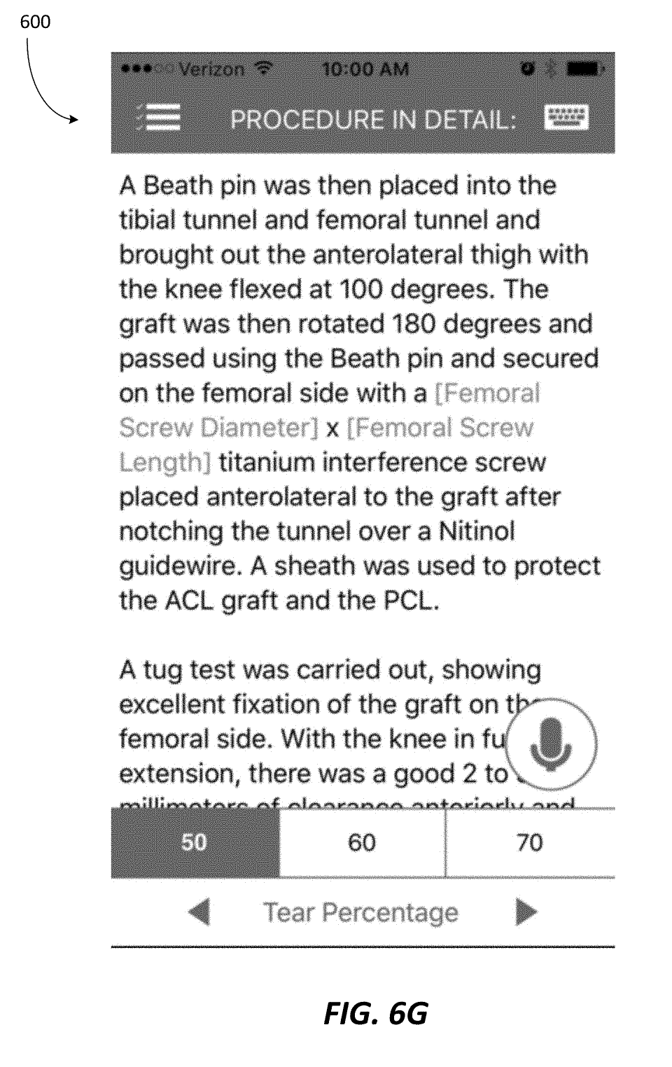

As discussed above, and in further detail below in connection with the screenshots illustrated in FIGS. 6A-6G, to facilitate efficient completion of the electronic document, content to be inserted into a variable field may be presented as a plurality selectable options, each option indicating specific content that can be inserted into the active field upon selection of the option by the user. The content indicated by a respective selectable option may display the actual content that will be inserted, a shorthand for the content, a class or category indicating the subject matter corresponding to the respective variable field, or any other suitable indication of the content to be inserted upon selection of the respective selectable option (e.g., any indication that allows the user to quickly ascertain the nature of the content corresponding to the respective variable field.

According to some embodiments, each variable field is linked to or otherwise associated with information that facilitates appropriate content being inserted into the respective variable field, including any one or combination of a description of the variable field (e.g., succinct descriptor that identifies the type of content associated with the variable field), a plurality of selectable options indicating possible content to be inserted into the respective variable field, and the actual content corresponding to each selectable option (e.g., the actual content inserted into the variable field when the corresponding selectable option is chosen). This information may be stored as part of, or in association with, the template that is used to populate the electronic document and used to assist the user in completing the documentation of the patient encounter (e.g., by allowing the user to select from a plurality of selectable options to quickly have the associated content inserted into the variable field), examples of some techniques of which are described in further detail below. Completing variable fields via respective selectable options provides an efficient technique in assisting a user in documenting a medical encounter, however, the aspects are not limited to using this technique, as the inventor has developed further techniques that facilitate completing a medical report including, but not limited to, using default content, speech input, typing via keyboard or keypad input, etc., some examples of which are described in further detail below. As discussed above, a variable field may be any construct that indicates that specific content should be added, inserted, reviewed, edited and/or confirmed and that has one or more associated mechanisms that facilitates adding, inserting, reviewing and/or editing content to or for the variable field.

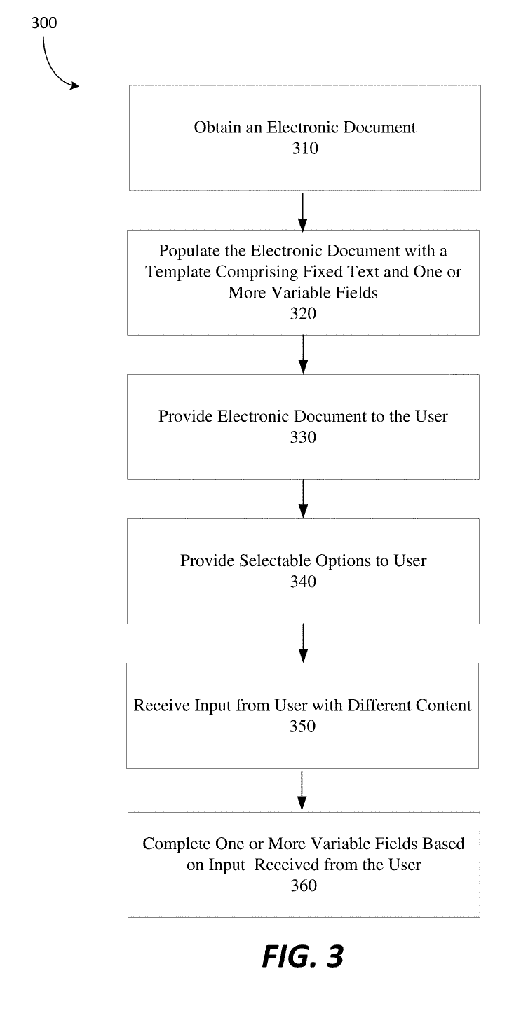

FIG. 3 is a flow chart illustrating a method of assisting a user in completing variable fields of a smart medical document, in accordance with some embodiments. Method 300 may be performed, for example, using appropriate components of system 100 illustrated in FIG. 1. Method 300 may be performed, for example, using appropriate components of system 100 illustrated in FIG. 1. In method 300, acts 310-340 may be similar to acts 210-240 described in connection with method 200 illustrated in the flow chart of FIG. 2, for example, in that a smart medical document is provided to a user by obtaining an electronic document and populating the electronic document with standard content and one or more variable fields having associated selectable options for populating the respective variable field with content. Any of the techniques described above in connection with FIG. 2, or any other technique described herein, may be performed in connection with performing method 300.

In viewing the selectable options for an active field, the user may determine that it is desirable to insert content that differs, at least in some respect, from the content indicated by the plurality of selectable options. In act 350, input from the user is received that differs from the content indicated by the plurality of selectable options presented to the user. The input from the user may be received via any suitable means. For example, the user may speak the content that is desired to be inserted into the active field. The speech input conveying the desired content may be provided to the device on which the electronic document is being displayed (e.g., via a microphone integrated with or external to the device) and processed via ASR to produce a text output corresponding to the speech input that may then be inserted into the active field. As discussed above in connection with FIG. 1, ASR may be performed using a local ASR component, a remote ASR component, or a combination of both. The recognition result inserted into the active field may then be reviewed by the user and edited as needed. To facilitate use input via speech, an interface element (e.g., an icon of a microphone) may be provided that, when selected by the user, indicates to the system that the user intends to input content for the active field via speech.

According to some embodiments, the user may initiate speech input or engage with the device via speech using a voice trigger, such as a keyword or phrase that the system understands and that indicates that subsequent speech is intended as input to the system. The term “voice trigger” refers to any spoken word or phrase that engages a speech enabled device or system to acquire and recognize speech input. Familiar examples of voice triggers include “Ski,” “Alexa,” “Hello, Dragon,” and the like that engage their respective devices to process subsequent speech input.

As another example, the voice trigger for a virtual medical assistant produced by Nuance Communications, Inc. is “Florence,” which voice trigger can be spoken to engage the virtual assistant to provide free-form speech input to the virtual assistant to facilitate performing one or more medical tasks, examples of which are described in U.S. Published Application No. 2014/0249830, filed Mar. 1, 2013 and titled “Virtual Medical Assistant Methods and Apparatus,” which is herein incorporated by reference in its entirety. According to some embodiments, the medical documentation system includes or has access to voice response technology that allows the user to provide speech input by engaging the system using a voice trigger, some examples of which are described in further detail below.

According to other embodiments, the user may use a keyboard or keypad (e.g., via a physical keyboard or keypad integrated with or connected, wired or wirelessly, to the device on which the user is completing the electronic document, or via a digital keyboard presented on the display of the device, etc.) to type content that differs from that indicated by the plurality of selectable options. According to some embodiments, the user may complete a variable field with content different than presented by the plurality of selectable options by first selecting one of the selectable options to insert the corresponding content and then editing the content as desired (e.g., via speech, typing, etc.).

In act 360, the active field is completed based on the input received from the user. It should be appreciated that this technique allows the user to enter information into a variable field that is different from the content indicated by the corresponding selectable options, allowing the user or medical professional to use their judgement and discretion completing the electronic document. In these instances, the plurality of selectable options may still be informative to the user, providing an indication of the content corresponding to the respective variable field, even though the user decides to depart, to some extent, from the content indicated by the selectable options. Thus, the selectable options presented to the user may still assist in allowing the user to quickly ascertain the nature of the content to be inserted into the corresponding field, even though the user ultimately decides to input different information (e.g., information that is specific to the particular patient encounter, information that is not completely captured by the available selectable options, content that the user prefers, etc.).

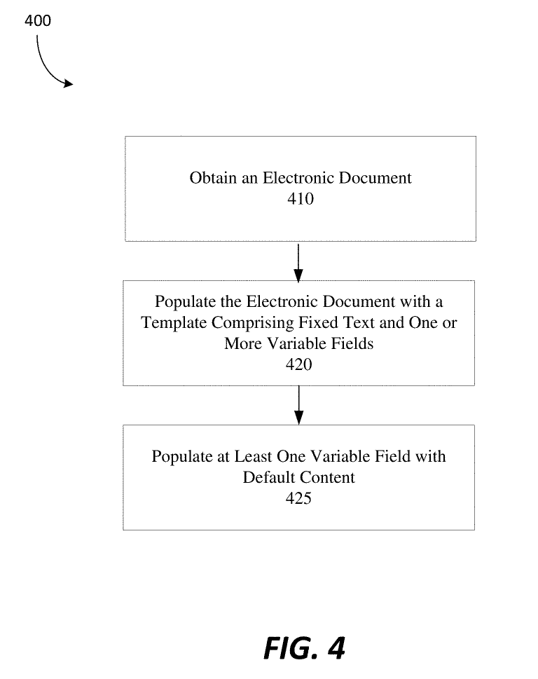

FIG. 4 is a flow chart illustrating a method of assisting a user in completing variable fields of a smart medical document and, in particular, populating an electronic document with default content, in accordance with some embodiments. Method 400 may be performed, for example, using appropriate components of system 100 illustrated in FIG. 1. In method 400, acts 410 and 420 may be similar to acts 210 and 220 described in connection with method 200 illustrated in the flow chart of FIG. 2, for example, in that these acts provide a smart medical document to a user by obtaining an electronic document and populating the electronic document with standard content and one or more variable fields. Method 400 may also use any of the techniques for assisting in the completion of a medical report described in connection with FIG. 2 or FIG. 3, or any other technique described herein. As discussed above, the inventor has appreciated that completing an electronic document may be facilitated by providing default content to the user, so that if particular default content is satisfactory to the user, no further input may be required to complete the corresponding variable field.

To this end, in act 425, at least one of the variable fields in the electronic document is populated with default content. As used herein, default content refers to any content that is used to populate a variable field without the user having to specify, input or otherwise instruct the content to be inserted into the variable field. The default content may be obtained from any suitable source including, but not limited to, any one or combination of selecting the content indicated by one of the selectable options associated with the respective variable field as the default content, inferring the default content from patient records, selecting the default content based on user preference and/or based on previous input from the user (e.g., based on a past history of how the user completed the variable field), etc. Accordingly, in some embodiments, default content can be customized for the particular user, though the technique of providing default content is not limited in this respect.

Default content may be populated at any time during the process of completing the electronic document obtained in act 410. For example, one or more variable fields may be populated with default content prior to, concurrently with, and/or after the population of the electronic document with the template. According to some embodiments, one or more variable fields are populated while, and/or in response to, the user providing input to, or completing, other variable fields. For example, when a user completes a variable field with specific content, other variable fields associate with the same subject matter may be automatically populated using the specific content as a default. Thus, when the user navigates to such a variable field, it will already be populated with the content previously selected by the user, eliminating the need for the user to again provide input to populate the field. In this way, content for a particular type of variable field may need to be selected by the user only once, with the remaining variable fields being automatically populated using this selection as default content. Additionally, the content of some variable fields may depend on the content of other variable fields. In such circumstances, when a user completes an active field, the content provided may indicate or restrict the content of another variable field. Thus, a variable field may be populated with default content based on content that selected or input to complete another variable field having a relationship or dependency that suggests or specifies what the content should be, or that constrains another variable field to particular content.

As discussed above, a variable field may be populated with default content selected from the content indicated by one of the selectable options corresponding to the respective variable field. The selectable option to use as the source of the default content to populate a variable field may be selected in any manner, including, in addition to any of the techniques described above (e.g., based on patient records, user preferences or past history), selecting the first of the plurality of selectable options, randomly or pseudo-randomly selecting one of the selectable options, selecting the selectable option that is most commonly chosen across multiple users, or using any other criteria for choosing one of the plurality of selectable option as the source of default content to populate the corresponding variable field.

As an example of selecting default content based on user preferences or past history, a medical procedure may involve a step that can be performed using a number of different techniques, which may be presented to a medical professional via the selectable options corresponding to a respective variable field that needs to be completed for the specific instance of the medical procedure that the medical professional is currently documenting via the smart medical document. If the medical professional has in the past used one of the techniques more often than the other techniques in performing this procedure, or the medical professional used one of the techniques the last time the procedure was performed, etc., that technique may be used as default content to populate the corresponding variable field.

As an example of utilizing patient records to select default content, if a patient for whom a medical professional is documenting a knee surgery has previously come in for a consultation about a right knee surgery, or underwent a magnetic resonance imaging procedure on the right knee, the patient records documenting these encounters may be used to infer that the right knee underwent the surgery, and the variable fields corresponding to the laterality of the surgery may be populated with the default content of “right” based on the likelihood that this was also the knee that was operated on. It should be appreciated that one or more variable fields may be populated with default content selected in other ways, as the aspects are not limited in this respect. Populating variable fields with default content facilitates more efficient completion of a medical report as it may eliminate the need for a user to provide further input in connection with completing these variable fields.

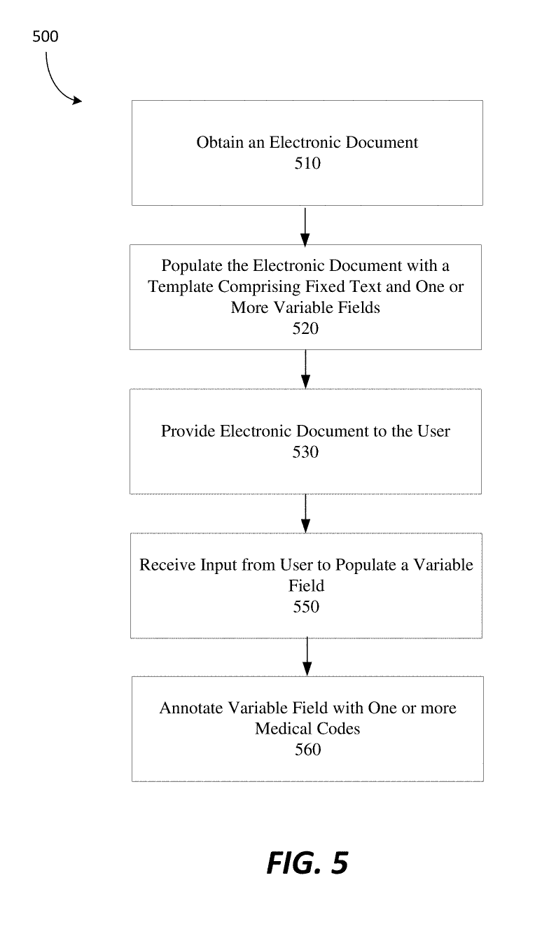

FIG. 5 is a flow chart illustrating a method of assisting a user in completing variable fields of a smart medical document and, in particular, annotating the documentation with medical coding information, in accordance with some embodiments. Method 500 may be performed, for example, using appropriate components of system 100 illustrated in FIG. 1. In method 500, acts 510-530 may be similar to acts 210-230 described in connection with method 200 illustrated in the flow chart of FIG. 2. In particular, these act may similarly provide a user with a smart medical document by obtaining an electronic document and populating the electronic document with standard content and one or more variable fields. It should be appreciated that any of the techniques described above in connection with FIGS. 2-4 may be performed in connection with performing method 500. As discussed above, the inventor has appreciated that assigning medical codes (e.g., medical billing codes) to a medical report may improve the medical documentation process by automatically providing medical codes that can be used, for example, for billing and/or reimbursement purposes.

To this end, method 500 provides means for annotating variable fields with one or more medical codes to facilitate computer assisted coding aspects of the medical documentation process. For example, in act 550 input from the user may be received to populate or complete a variable field using any of the techniques described herein. In act 560, in response to a variable field being populated based on user input, the populated variable field may be annotated with one or more medical codes, with metadata indicating or encoding one or more medical codes, and/or with information about an associated medical code (e.g., an index into a billing database, etc.).

According to some embodiments, selectable options associated with one or variable fields may be linked to or associated with one or more medical codes, or metadata that encodes one or more medical billing codes, etc. When a user chooses one of the selectable options, the respective variable field may be annotated with the associated medical code(s) and/or corresponding metadata to assist, for example, in coding the patient encounter for billing and/or reimbursement, or to facilitate other coding aspects of the medical documentation process. For example, the annotated variable fields may be used by a computer assisted coding (CAC) system configured to suggest billing codes for a patient encounter to a customer. The suggested medical codes may be reviewed and/or edited by a medical coder for submission to an insure company or payment provider for reimbursement. In this respect, variable fields may be annotated, where appropriate, with internal medical codes or other metadata that can be used to generate billing codes according to whichever set of standardized (or non-standard) billing codes that a particular customer utilizes. In this manner, the medical code annotations may be utilized for performing CAC with a number of different customers.

According to some embodiments, the metadata may provide information on corresponding billing codes in a billing database to which the medical documentation system has access to (e.g., medical coding database 160 illustrated in exemplary system 100 illustrated in FIG. 1). Annotating one or more variable fields of an electronic document with medical coding information provides CAC functionality and/or may facilitate other aspects of medical documentation. However, it should be appreciated that the above described medical coding functionality (e.g., functionality provided by performing act 560) is not a requirement, and smart medical documentation may be achieved without implementing this functionality (e.g., without annotating variable fields with medical coding information), as the aspects are not limited in this respect.

It should be appreciated that, in embodiments that support medical code annotations, each variable field populated in an electronic document need not have an associated medical code and that one or more variable fields may not have a medical code associated with any of the corresponding selectable options for the respective variable field. As discussed above, a user may input content that differs from the selectable options presented to the user. According to some embodiments, the medical documentation system may respond by evaluating the content (e.g., by performing natural language processing alone, or in conjunction with a medical coding database or other CAC system) to determine whether to annotate the content with one or more medical codes. For example, the medical documentation system that generated the electronic document being completed may utilize a natural language understanding (NLU) engine that performs natural language processing on the content provided by the user, either in isolation, or in conjunction with proximate standard content and/or one or more other variable fields that have been populated, to extract one or more medical facts and automatically provide one or more annotations, including one or more medical codes believed to be pertinent to the language analyzed. In this manner, medical code annotations may be provided by the system even in the absence of any preexisting association between a variable field and one or more medical codes.

It should be further appreciated that standard content in the electronic document, which may or may not have one or more variable fields within it, may also be annotated with one or more medical codes. For annotated standard content having one or more variable fields within the standard content, the one or more medical codes annotating the standard content may be modified (e.g., one or more medical codes may be deleted, added or changed) upon completion of the one or more variable fields, or the one or more medical codes may remain unchanged in response to completing the one or more variable fields, as techniques for annotating the electronic document with one or more medical codes is not limited in this respect.

Described above and in further detail below in connection with an exemplary smart medical document are techniques that facilitate documenting a patient encounter. It should be appreciated that the various techniques described herein to assist a user in documenting a patient encounter via a smart medical document may be used alone or in any combination, as the aspect are not limited in this respect. Examples of at least some of these techniques are described below in connection with the exemplary smart medical document illustrated via the screen shots illustrated in FIGS. 6A-6G.

In particular, FIGS. 6A-6G illustrate screen shots of an exemplary smart medical document 600 generated to assist a medical professional in documenting a knee surgery performed on a patient, in accordance with some embodiments. In this example, the user interacts with smart medical document 600 via the user's smartphone with an interface for doing so presented the device's display. The screen shots illustrated in FIGS. 6A-6G demonstrate a number of techniques that may be employed to populate the smart electronic document to facilitate efficient, cost effective medical documentation that may reduce the burden on medical professionals and/or may provide a workflow that avoids one or more points where errors are frequently introduced, for example, by eliminating human transcriptionists that contribute not only to error, but to significant costs and delay in documenting a patient encounter.

The screen shots in FIGS. 6A-C illustrate a beginning portion of the electronic document (e.g., the beginning of the document) displayed to the user with standard content 610 and a plurality of variable fields 620 (i.e., variable fields 620a-620e). In this example, each variable field 620 needing user input is presented using a text descriptor that provides context to the medical professional as to the type of content intended for the respective variable field so that the user can quickly ascertain the nature of the variable field (see e.g., text descriptors “Lachman Test,” “Pivot Shift Test,” “Laterality,” and “Incision Length” in the screen shots of FIGS. 6A-C). To further assist, each variable field may be differentiated from the standard content 610 using one or more visual indicators that allows the user to quickly identify the variable fields that need to be completed. In FIGS. 6A and 6B, the variable fields are visually differentiated from the standard content using brackets. However, any one or combination of techniques may be used to present variable fields differently, such as using colored text, emphasis (e.g., highlighting, different font or font size, bold, italics, underline, ALL-CAPS, etc.) and/or any other technique that identifies the variable fields and/or differentiates the variable fields from the surrounding standard content.

As discussed above, standard content 610 may include standard or custom language that can be re-used, in part or in full, across procedures of the this type. For example, standard content 610 includes a standard narrative of a knee surgery that may apply to each performance of the procedure, with variable fields 620 representing information needed to document a specific performance of the procedure. Standard content 610 may be obtained from any source, including a repository of standard language and narrative, language and/or narrative previously provided by the user (e.g., language that the user has provided and would like to re-use), or from any suitable source. As such, populating medical document 600 with fixed text 610 relieves the user of the burden of having to dictate or otherwise provide this relatively substantial amount of documentation each time a specific instance of the procedure is performed, saving the user substantial time in documenting a specific patient encounter.

Smart medical document 600 may further comprise a plurality of interface elements 630 (e.g., 630a, 630b and 630c in FIG. 6A) that can be used to present selectable options for each respective variable field 620. In particular, interface elements 630 present selectable options that each indicate content that can be inserted into the currently active field when the respective option is selected (e.g., selected via a touch display, mouse click, etc.), as discussed in further detail below. According to some embodiments, a field descriptor 640 is provided to indicate which of the variable fields in currently active field and, to this end, may match the text descriptor used in displaying the variable field to which it is associated. Interface elements 650 (e.g., 650a and 650b) may also be presented to let the user navigate to the next or previous variable field, resulting in the interface elements 630 and 640 to be updated with the information of the variable field that is navigated to. Exemplary smart medical document 600 also presents icons 660 and 670 that allow the user to input content into an active field via speech or typing, respectively, including using the respective modality to choose one of the selectable options presented for the active field.

As discussed above, smart medical document 600 provides documentation information corresponding to a knee surgery, and the portion illustrated in FIGS. 6A-6C presents narrative corresponding to the beginning of the procedure. FIGS. 6A and 6B illustrate the user providing input to populate the first two variable fields 620a and 620b, which correspond to respective clinical tests that are frequently performed prior to performing knee surgery, to quickly document the results of these clinical tests. Specifically, variable fields 620a and 620b are associated with the Lachman and Pivot Shift tests, respectively, and are presented to prompt the user to provide input to populate variable fields 620a and 620b with the results of the respective test.

Briefly, the Lachman test is a clinical test for diagnosing anterior cruciate ligament (ACL) injury and may provide an effective measure of the degree of ACL laxity. The Pivot Shift test is another clinical test for diagnosing ACL injury and may provide an effective indication of instability. The Lachman test involves a particular manipulation of the leg and measures translation of the tibia relative to the contralateral leg, and is graded according to the table below. The Pivot Shift also involves manipulation of the leg and measures the displacement of the medial and lateral plateau, and is also graded according to the table below.

| | Grade 1 (1+) | Grade 2 (2+) | Grade 3 (3+) |
|---|---|---|---|
| Lachman | 1-5 mm increased | 5-10 mm increased | >10 mm increased |
| Test | translation | translation | translation |
| Pivot | Pivot glide: | Pivot shift: | Locking: |
| Test | Medial plateau: | Medial plateau: | Medial plateau: |
| | 5 mm | 10 mm | 15 mm |
| | Lateral plateau: | Lateral plateau: | Lateral plateau: |
| | 12 mm | 18 mm | 22 mm |

Thus, a user can complete the variable fields corresponding to the Lachman and Pivot shift tests by choosing the selectable option corresponding to the grade each test received upon performance of the respective test on the patient. As illustrated in FIG. 6A, variable field 620a is active so field descriptor 640 displays the description “Lachman Test” to indicate to the user that the active field correspond to the Lachman test, and interface elements 630 present selectable options indicating the grade of the Lachman test that the user can choose from to populate variable field 620a with the result of the Lachman test. In FIG. 6A, the user has selected option 630a corresponding to the “Grade 1” option, which populates the variable field 630a with the corresponding content “1+,” thereby documenting that the Lachman test was positive and the degree of translation the tibia underwent in performing the Lachman test on this patient prior to surgery.

The user may choose one of the selectable options in any suitable way. For example, the user may have chosen the selectable option “Grade 1” by selecting interface element 630 via a touch capable display, using a computer mouse, activating the microphone icon 660 and speaking the words “Grade 1,” by toggling through the selectable option via a keyboard or keypad (e.g., by activating a digital keypad by selecting keyboard/keypad icon 670) or using any other suitable means. It should be appreciated that in FIG. 6A, the selectable option of “Grade 1,” when selected, inserts corresponding content that is different into the respective variable field (i.e., the content “1+” is inserted into variable field 620a and not the text “Grade 1”). This technique may be beneficial when the content to be inserted into a variable field is lengthy. In those circumstances, making the selectable option corresponding content be a shorthand, abbreviation or some other abridged version of the content that conveys the nature of the content may provide for an intuitive and efficient mechanism by which relatively longer content can be inserted into a variable field using the selectable options.

It should be appreciated that the indicator presented with a selectable option may be the same as the content that is inserted into the respective variable field. For example, the indicators for the “Laterality” selectable options (see FIG. 6B) may be “right,” “left” and “both,” which may, when selected, insert content of “right,” “left” and “co-lateral,” into the respective field, the first two being the same as the selectable option and the third being different. As also shown in FIG. 6A, the next variable field 620b is displayed using the field descriptor “Pivot Shift Test” to indicate to the user that the next variable field corresponds to the results of the Pivot Shift test. As shown in FIG. 6B, after selecting the Grade 1 option for the Lachman text, variable field 620a was populated with the indicated content, and variable field 620b was made active, resulting in the interface elements 630 and 640 being updated with the selectable options for the Pivot Shift test and with the field description “Pivot Shift Test,” respectively. The active field may have been transitioned from variable field 620a to variable field 620b by various means including, but not limited to, automatically in response to the user completing variable field 620a, in response to the user activating interface element 650b, in responsive to the user clicking on variable field 620b using a computer mouse, or using any other suitable technique.

As shown in FIG. 6B, the user also selects the “Grade 1” option for the Pivot Shift test to insert the content “1+” into variable field 620b. To assist the user, variable fields that have been populated may be visually differentiated from variable fields that have not been populated using any of the techniques described above in connection with differentiating variable fields from standard content. For example, variable fields that have been populated may be given a different text color than variables fields still needing content, or variable fields that have not yet been populated may be visually differentiated using highlighting or otherwise emphasis that may be removed once content has been inserted into the respective variable field.

In addition to the technique of using selectable options to insert content into variable fields, FIGS. 6A and 6B illustrate another technique for facilitating efficient completion of the smart medical document. As discussed above, one or more variable fields may be populated using default content. In FIGS. 6A and 6B, variable fields 620c, 620d and 620e correspond to the laterality of the knee surgery. In the example illustrated in FIG. 6B, no default content is used for this portion of the document so that the laterality fields are not populated and instead are displayed with their field descriptor “Laterality.” To populate the laterality fields, the user may navigate to each and indicate which knee was operated on using any of the mechanisms described above (e.g., by selecting one of the selectable options for each laterality field in turn when it is made active). However, the laterality fields (and any other variable field) may alternatively be populated with default content so that the user need not attend to populating each of these fields. For example, as illustrated in FIG. 6A, the laterality fields are populated with default content specifying that the right knee was the subject of the operation.

The default content may be selected using any of the techniques described herein, for example, any of the techniques describe above in connection with performing act 425 of method 400 illustrated by the flow chart of FIG. 4 (e.g., by automatically selecting one of the selectable options, by using information from the patient's record, by using past performance or preferences of the particular user, etc.). According to some embodiments, a variable field may initially be unpopulated (e.g., the laterality fields illustrated in FIG. 6B), but upon insertion of content in one variable field, other like variable fields may be automatically populated using the selected content as default content. For example, if laterality field 630c in FIG. 6B becomes the active field and the user selects “right,” variable fields 630d and 630e may be automatically populated with the right laterality as default content so that the user does not have to navigate and select the same content for each laterality field. Similarly, a selection of content for a variable field may facilitate selection of default content for other variable fields that are dependent on or are otherwise related such that the selection of content for one variable field suggests or constrains the content for another. Populating one or more variable fields with default content may significantly reduce the time and effort needed for the user to document the patient encounter.

As discussed above, a user may provide input to provide, indicate and/or confirm content for the electronic document using speech, either via an interface element displayed on the device (e.g., a microphone icon) or via a speech enabled interface element that allows the user to initiate speech input via a voice trigger. For example, to populate variable field 620a, the user may speak “Florence, Lachman is 1+” when variable field 620a is active to engage the system with the voice trigger “Florence” and to provide the speech input “Lachman is 1+” to instruct the system as to the content to be used to complete variable field 620a. The system may analyze the voice input and understand from the context of the variable field that the user is indicating that the Lachman test for the patient was given a grading of 1+ (e.g., using one or more natural languages processes) and, in response, populate variable field 620a accordingly.

FIG. 6C illustrates the portion of the document presented to the user in FIGS. 6A and 6B with variable fields 620a-620e populated with content, either via the user selecting content to be inserted into the respective variable field or, alternatively, by populating one or more variable fields with default content. Variable field 620f, which appears at the bottom of the viewable portion of the narrative, remains unpopulated and in need of user input. To view additional portions of the narrative, the user may navigate to variable field 620f using interface element 650b, scrolling, selecting variable field 620f via mouse click, etc., to continue documenting the patient encounter.

FIG. 6D illustrates a further portion of the narrative provided by standard content 610 of medical document 600 after the user has navigated to variable field 620f. In particular, variable field 620f is highlighted as the active field and associated information about the variable field is presented via interface elements 630 and 640. Specifically, variable field 620f is described as documenting “Incision Length” via field descriptor 640 (which is the same description used for the presentation of variable field 620f in the standard content, as is visible at the bottom of FIG. 6C) and selectable options of “5,” “6,” and “7” are presented indicating options for the respective length in centimeters of the incision that will be inserted into the variable field 620f if/when selected by the user. It should be appreciated that any number of selectable options may be presented and some variable fields may have, or need, more options than others. In FIG. 6D, variable field 620g was populated with default content (e.g., via automatically selecting one of the selectable options, using the patient's records, in response to the user having selected “30 mm” to populate a like field elsewhere in the document, etc.), and variable fields 620h-620k are presented with their field descriptors and await completion by the user.

FIGS. 6E-6G illustrate further portions of the standard content narrative of smart medical document 600 along with the corresponding variable fields to be populated with content based on input from the user. As shown in FIG. 6E, variable field 620i is populated with default content, as was like variable field 620g illustrated in FIG. 6D populated with the same content. The screen shots in FIGS. 6A-6G illustrate a number of techniques that allow a user to navigate through the standard content narrative of a smart medical document and efficiently provide input to populate the variable fields included there within. The inventor has further appreciated that, in some cases, a medical professional may want to populate variable fields with content without having to view or navigate through the corresponding standard content narrative. To this end, the inventor has developed a “quick-view” mode that allows the user to view the variable fields that need populating (or that need confirmation) without viewing the corresponding standard content. For example, the variable fields of the electronic document may be display as a list, table or other via some other organization that the allows the user to quickly view and provide input to complete the variable fields of the smart medical document. For a user who may have repeatedly documented a patient encounter of a particular type, the user may not need the context provided by the standard content to provide the necessary content for the variable fields.

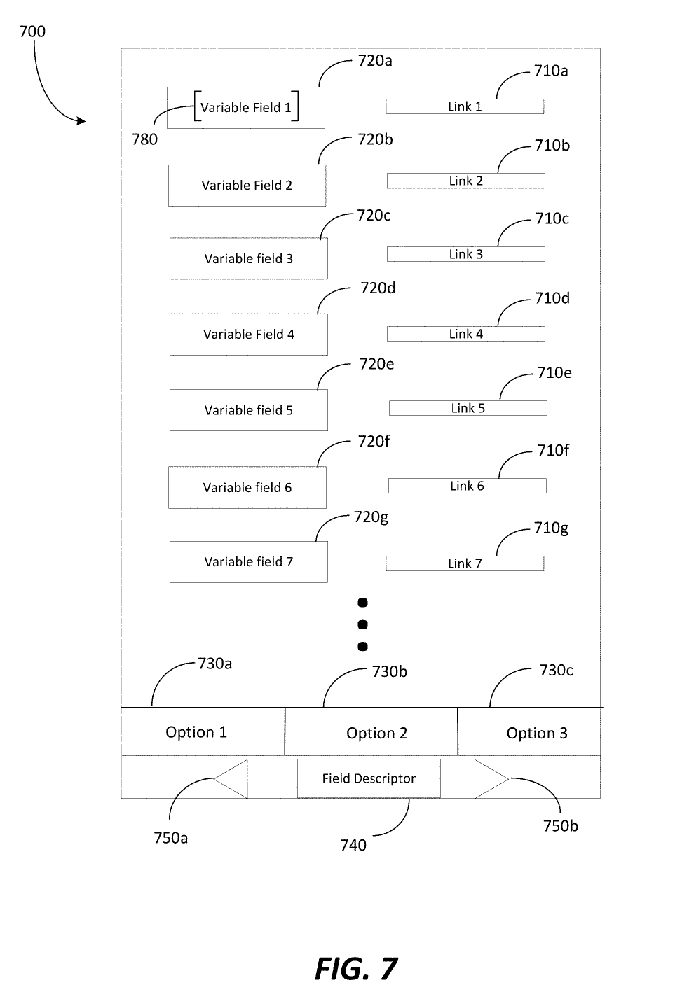

FIG. 7 illustrates an example of a “quick-view” mode of a smart medical document, in accordance with some embodiments. In the “quick-view” mode, the variable fields are displayed without the corresponding standard content. For example, exemplary variable fields 720a-720g may be displayed in list form to allow the user to quickly view variable fields in the document. As indicated by the ellipses, any number of variable field can be displayed and the view can be scrolled using any suitable interface mechanism.

Quick-view mode may also include interface elements similar or the same in functionality to the interface elements described above in connection with the full view mode illustrated in FIGS. 6A-6G. In particular, a plurality of selectable options may be presented via interface elements 730 (e.g., interface elements 730a-c) and field descriptor (e.g., an indicator of the subject matter of the active field, an excerpt from the standard content narrative, or other description that allows the user to understand the nature of the content to be provided to the respective variable field) may be provided via interface element 740 for the active field. As discussed above, the active field in the “quick-view” mode may be presented differently using an indicator 780, which may include any type of visual indicator including, but not limited to, bracketing, different colored text, emphasis such as highlighting, shading, different font or font sized, bolding, underline, etc., or any other mechanism that identifies the active field. The user may select which variable field to make active using interface elements 750 (e.g., back/previous arrow 750a and forward/next arrow 750b), or using any other suitable means (e.g., mouse click, speech, keyboard entry, etc.).

According to some embodiments, links 710 (e.g., links 710a-g) corresponding to respective variable fields are provided that allows the user to quickly link to the surrounding standard content if the user needs further context to populate the respective variable field. The corresponding link may present the corresponding text to the user, or it may switch the user to a full-view mode in which the standard content is displayed in conjunction with the variable fields (e.g., as illustrated in FIGS. 6A-6G), may make the corresponding variable field active in the new view. In this way, the user may quickly view and insert content into the variable fields, and may also view the accompanying standard content, if needed, by using the corresponding link 710. According to some embodiments, the link may instead be, or may display when selected, a brief excerpt from the standard content to provide some measure of context to the user, while avoiding displaying the full standard content narrative. According to some embodiments, links 710 may be, or link to, other descriptive text that differs from the standard content, but that provides some context to the user regarding the corresponding variable field.

It should be appreciated that the variable fields in the quick-view mode may be displayed in other ways, such as in a table, or may be grouped into categories (e.g., all like variable fields may be grouped together and, according to some embodiments, may all be populated with the same content in response to the user selecting content for one of the variable fields in the group). In this manner, a quick-view mode may further facilitate relatively quick and easy documenting of a patient encounter, allowing the user to streamline entry of content into the variable fields while still allowing the user to access the relevant context of the standard content (e.g., narrative) as needed. However, a quick-view mode is not a requirement and, in some embodiments, aspects of the full-view mode (e.g., as illustrated in FIGS. 6A-6G) and the quick-view mode (e.g., as illustrated in FIG. 7) may be combined to facilitate efficient completion of medical reports and to provide a more time and cost effective approach to medical documentation that reduces the potential for human error.

It should be appreciated that documenting a patient encounter via smart medical document techniques describe herein does not require a transcriptionist to be involved, as the user (e.g., a medical professional) can provide the needed input without having to dictate substantial amounts of information and, in many cases, without needing to dictate at all (depending on the preferences of the user). Thus, using one or any combination of the smart medical documentation techniques described herein facilitates reducing the time, cost and the frequency of errors in documenting a patient encounter with respect to conventional medical documentation processes and workflows.

The terms “electronic document” and “smart medical document” are used interchangeably throughout, and should be understood as representing any document generated by the system to be reviewed, processed, filled or otherwise used by a user using techniques described herein. The terms “text string” or “document text” are also used interchangeably throughout, and should be understood as representing any series of characters, including spaces, and can comprise multiple words in some embodiments.

Similarly, filling a variable field may refer to any means for associating a text string with the variable field. In some embodiments, the variable field may be filled by inserting the text string into the variable field on the display. However, a visual representation of the filling of the variable field is not necessary; in some embodiments the system may not display the filling of the variable field. For example, the text string may replace the variable field within the electronic document. In some embodiments, the system may leave the variable field in the electronic document, linked to the text string, while replacing it with the text string for display.

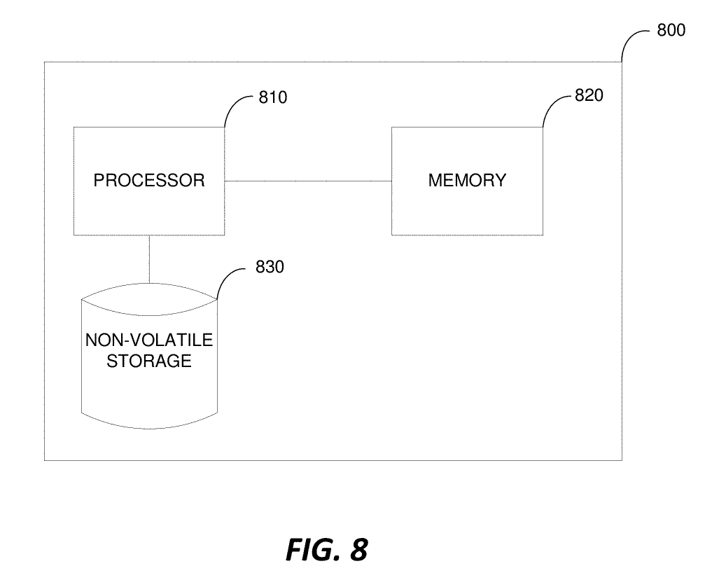

An illustrative implementation of a computer system 800 that may be used to perform any of the smart medical documentation techniques described herein is shown in FIG. 8. The computer system 800 may include one or more processors 810 and one or more non-transitory computer-readable storage media or storage devices (e.g., memory 820 and one or more non-volatile storage media 830). The processor 810 may control writing data to and reading data from the memory 820 and the non-volatile storage device 830 in any suitable manner, as the aspects of the invention described herein are not limited in this respect. To perform the functionality and/or techniques described herein, the processor 810 may execute one or more instructions stored in one or more computer-readable storage media (e.g., the memory 820, storage media, etc.), which may serve as non-transitory computer-readable storage media storing instructions for execution by the processor 810.

In connection with techniques for smart medical documentation described herein, code used to, for example, populating a template with standard content and variable fields, providing a user interface to facilitate a medical professional completing a medical report, or any other technique described herein, may be stored on one or more computer-readable storage media of computer system 800. Processor 810 may execute any such code to provide any of the medical documentation described herein. Any other software, programs or instructions described herein may also be stored and executed by computer system 800. It will be appreciated that computer code may be applied to any aspects of methods and techniques described herein.

Various inventive concepts may be embodied as at least one non-transitory computer readable storage medium (e.g., a computer memory, one or more floppy discs, compact discs, optical discs, magnetic tapes, flash memories, circuit configurations in Field Programmable Gate Arrays or other semiconductor devices, etc.) or a computer readable storage device encoded with one or more programs that, when executed on one or more computers or other processors, implement some of the various embodiments of the present invention. The non-transitory computer-readable medium or media may be transportable, such that the program or programs stored thereon may be loaded onto any computer resource to implement various aspects of the present invention as discussed above.

The terms “program,” “software,” and/or “application” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of one or more embodiments described herein need not reside on a single computer or processor, but may be distributed in a modular fashion among different computers or processors to implement various aspects of the present invention.

Processor-executable instructions may be in many forms, such as program modules, executed by one or more computers or other devices. Generally, program modules include routines, programs, objects, components, data structures, etc., that perform particular tasks or implement particular abstract data types. Typically, the functionality of the program modules may be combined or distributed as desired in various embodiments.

Also, data structures may be stored in one or more non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Also, various inventive concepts may be embodied as one or more processes, of which multiple examples have been provided. The acts performed as part of each process may be ordered in any suitable way. Accordingly, embodiments may be constructed in which acts are performed in an order different than illustrated, which may include performing some acts concurrently, even though shown as sequential acts in illustrative embodiments.

All definitions, as defined and used herein, should be understood to control over dictionary definitions, and/or ordinary meanings of the defined terms.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

What is claimed is:

1. A system for producing documentation, the system comprising:
an electronic display;
at least one storage medium storing processor-executable instructions;
at least one processor capable of accessing the at least one storage medium, wherein when the processor-executable instructions are executed by the at least one processor, the at least one processor is configured to perform:
populating an electronic document with a template comprising standard content and a plurality of variable fields, each of the plurality of variable fields having an associated plurality of selectable options that indicate respective content to be inserted into the respective variable field upon selection of the respective selectable option;
displaying the populated electronic document to a user via the electronic display;
in response to a first variable field of the plurality of variable fields in the displayed electronic document becoming active, displaying to the user via the electronic display the associated plurality of selectable options; and
in response to the user selecting one of the plurality of displayed selectable options, inserting into the first variable field the respective content indicated by the displayed selectable option selected by the user.

2. The system of claim 1, wherein the at least one processor is configured to perform displaying, for each of the plurality of displayed selectable options, a respective text string indicating the content to be inserted into the first variable field upon selection of the respective selectable option, wherein the respective text string is different from the content.

3. The system of claim 1, wherein the at least one processor is configured to perform displaying the plurality of selectable options corresponding to the first variable field via interface elements, selectable by touch, in a display area delineated from the display are for the plurality of variable fields.

4. The system of claim 1, wherein the at least one processor is configured to display the plurality of variable fields within the standard content.

5. The system of claim 1, wherein the at least one processor is configured to display the plurality of variable fields as a list separate from the standard content.

6. The system of claim 5, wherein the at least one processor is configured to display a link in associated with each of the plurality of variable fields, each link providing context for the associated variable field when selected.

7. The system of claim 6, wherein each link displays corresponding standard content to provide context for the associated variable field when selected.

8. The system of claim 7, wherein each link displays the associated variable field within the standard content to provide context for the associated variable field when selected.

9. The system of claim 1, wherein the at least one processor is configured to automatically populate at least one of the plurality of variable fields with default content.

10. The system of claim 9, wherein the at least one processor is configured to determine the default content to populate at least one of the plurality of variable fields by automatically selecting content indicated by one of the plurality of selectable options associated with the at least one of the plurality of variable fields.

11. The system of claim 9, wherein the at least one processor is configured to determine the default content to populate at least one of the plurality of variable fields accessing at least one patient record.

12. The system of claim 9, wherein the at least one processor is configured to determine the default content to populate at least one of the plurality of variable fields by using as the default content, content selected by the user to be inserted into at least one other variable field.

13. The system of claim 9, wherein the at least one processor is configured to determine the default content to populate at least one of the plurality of variable fields based on content selected by the user to be inserted into at least one other variable field.

14. The system of claim 9, wherein the at least one processor is configured to determine the default content to populate at least one of the plurality of variable fields based on past performance by and/or preferences of the user.

15. The system of claim 1, wherein the electronic document is a medical report documenting a patient encounter, and wherein the at least one processor is configured to, in response to the user selecting one of the plurality of displayed selectable options associated with the first variable field, annotate the first variable field with medical coding information.

16. The system of claim 15, wherein the at least one processor is configured to, in response to the user selecting one of the plurality of displayed selectable options associated with the first variable field, annotate the first variable field with one or more medical codes.

17. The system of claim 1, wherein the at least one processor is configured to display an interface element that allows the user to provide input via speech.

18. The system of claim 1, wherein the at least one processor is configured to display the standard content, variable fields that have been populated and variable fields that have not been populated differently from one another.

19. The system of claim 18, wherein the at least one processor is configured to include in the display of each variable field that has not been populated a description of the respective variable field.

20. The system of claim 1, wherein the storage medium stores a plurality of templates, each of the plurality of templates associated with a corresponding type of patient encounter and each comprising standard content providing narrative corresponding to the type of patient encounter and a plurality of variable fields associated with a respective plurality of selectable options indicating respective content that can be inserted into the associated variable field.

21. At least one non-transitory processor-readable storage medium storing processor-executable instructions that, when executed, perform a method comprising:
populating an electronic document with a template comprising standard content and a plurality of variable fields, each of the plurality of variable fields having an associated plurality of selectable options that indicate respective content to be inserted into the respective variable field upon selection of the respective selectable option;
displaying the populated electronic document to a user via the electronic display;
in response to a first variable field of the one or more variable fields in the displayed electronic document becoming active, displaying to the user via the electronic display the associated plurality of selectable options; and
in response to the user selecting one of the plurality of displayed selectable options, inserting into the first variable field the respective content indicated by the displayed selectable option selected by the user.

22. A method comprising:
populating an electronic document with a template comprising standard content and a plurality of variable fields, each of the plurality of variable fields having an associated plurality of selectable options that indicate respective content to be inserted into the respective variable field upon selection of the respective selectable option;
displaying the populated electronic document to a user via the electronic display;
in response to a first variable field of the plurality of variable fields in the displayed electronic document becoming active, displaying to the user via the electronic display the associated plurality of selectable options; and
in response to the user selecting one of the plurality of displayed selectable options, inserting into the first variable field the respective content indicated by the displayed selectable option selected by the user.
